(19) United States
(12) Patent Application Publication
(10) Pub. No.: US 2026/0170463 A1
(43) Pub. Date: Jun. 18, 2026

(54) THREE-DIMENSIONAL SPACE-BASED COLLABORATION SUPPORT SYSTEM USING BUILDING INFORMATION MODEL

(71) Applicant: CONWORTH, Seoul (KR)

(72) Inventors: KI IN BANG, Gyeonggi-do (KR); JI HOON LEE, Seoul (KR)

(21) Appl. No.: 18/853,762

(22) PCT Filed: Apr. 29, 2024
(86) PCT No.: PCT/KR2024/005757

§ 371 Date: Oct. 3, 2024

(30) Foreign Application Priority Data
Apr. 27, 2023 (KR) 10-2023-0055379

(51) Int. Cl. G06Q 10/1093

(52) U.S. Cl. CPC G06Q 10/1093

(57) ABSTRACT

A three-dimensional space-based collaboration support system uses a building information model. The three-dimensional space-based collaboration support system includes a facility data storage unit configured for storing facility data, a rendering unit configured for rendering Building Information Model (BIM) data based on the facility data, and a collaboration support unit configured for providing and sharing the BIM data to a plurality of user terminals, outputting the BIM data through each user terminal, creating an issue report based on three-dimensional location-based issue data for a facility inputted through a specific user terminal, and transmitting a meeting convening alarm to a user terminals corresponding to the issue report, and supporting a meeting to be held between the user terminals receiving the meeting convening alarm.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2024/005757 filed on Apr. 29, 2024, which claims priority to the benefit of Korean Patent Application No. 10-2023-0055379 filed on Apr. 27, 2023 in the Korean Intellectual Property Office, the entire contents of which are incorporated herein by reference.

### BACKGROUND

### 1. Technical Field

The present invention relates to a three-dimensional space-based collaboration support system using a building information model, and more specifically, to a three-dimensional space-based collaboration support system using a building information model that provides various construction and safety-related issues raised at a construction site to be shared with each other by various interested parties based on three-dimensional location information, enabling intuitive issue identification without actually visiting the site or convening an offline meeting, and facilitating the delivery of necessary information and consultation to resolve the issues.

### 2. Background Art

In general, Building Information Modeling (BIM) is a technology that models the three-dimensional geometry of a building by using parametric solid modeling techniques, unlike previous CAD systems, and produces and manages all information applied in various fields throughout the entire life cycle of a building, from the initial conceptual design of a building to the maintenance phase, and refers to a three-dimensional based information system that has the actual shape and information of the building through BIM technology.

However, at the actual construction site, even though workers check various issues that occur during the building construction and constructing process, there was no system to immediately reflect the issues as BIM data and share or discuss the issues with related department workers and managers. In the past, when such issues occurs, workers first verbally explain the location of the issue by using a radio or other communication equipment, transmit the issue through text message input, or take a photo or video and send the photo or video to other workers or managers. Some of the other workers or managers may immediately recognize the location of the issue, while others may not, and when there are many people from the departments involved, it is necessary to explain the location of the issue occurrence and the details of the issue one by one.

Because this point is a barrier to better communication, collaboration, and support for progressing the meetings for the issue, there is a need for technology that enables intuitive issue recognition without physical site visits or convening offline meetings, and enables the delivery of necessary information for issue resolution and smooth consultation.

### SUMMARY

The present invention is conceived in response to the background art, and has been made in an effort to provide a three-dimensional space-based collaboration support system using a building information model that provides various construction and safety-related issues raised at a construction site to be shared with each other by various interested parties based on three-dimensional location information, enabling intuitive issue identification without actually visiting the site or convening an offline meeting, and facilitating the delivery of necessary information and consultation to resolve the issues.

An exemplary embodiment of the present invention provides a three-dimensional space-based collaboration support system using a building information model, the three-dimensional space-based collaboration support system including: a facility data storage unit 110 for storing facility data; a rendering unit 120 for rendering Building Information Model BIM data based on the facility data; and a collaboration support unit 130 for providing the BIM data to a plurality of user terminals, outputting the BIM data through each user terminal, creating an issue report based on three-dimensional location-based issue data for a facility inputted through a specific user terminal, and transmitting a meeting convening alarm to a user terminals corresponding to the issue report.

In the exemplary embodiment, the facility data may include any one or more of two-dimensional drawing data, three-dimensional drawing data, terrain data, construction data, and building data for the facility.

In the exemplary embodiment, the three-dimensional location-based issue data inputted via the user terminal may include location data on the three-dimensional drawing data selected via the user terminal, photo data or video data taken via the user terminal.

In the exemplary embodiment, the collaboration support unit 130 may select an account of a person in charge corresponding to location data in the three-dimensional drawing data selected via the user terminal from among a plurality of pre-registered accounts, and transmit the issue report to a user terminal corresponding to the selected account.

In the exemplary embodiment, the collaboration support unit 130 may transmit the issue report to a user terminal corresponding to an account of a person in charge, which is selected directly through the user terminal that has inputted the three-dimensional location-based issue data from among the plurality of pre-registered accounts.

In the exemplary embodiment, the collaboration support unit 130 may connect user terminals that have received the meeting convening alarm to each other via a network to execute a video conference processor, so that a video conference is conducted between the user terminals.

In the exemplary embodiment, the collaboration support unit 130 may cause the BIM data corresponding to the issue report to be output on the user terminal participating in the video conference.

In the exemplary embodiment, the collaboration support unit 130 may transmit the meeting convening alarm to user terminals corresponding to accounts grouped based on the location data so that the accounts grouped based on the location data are capable of participating in the video conference.

In the exemplary embodiment, the collaboration support unit 130 may automatically convert voice output data generated in a course of the video conference into text data, and transmits and outputs the converted text data to the user terminals corresponding to the accounts grouped based on the location data.

In the exemplary embodiment, the collaboration support unit 130 may cause location data corresponding to the three-dimensional location-based issue data to be displayed and output as a specific symbol in the three-dimensional virtual space of the BIM data, and provide the issue report corresponding to the symbol so that the viewing, modification, or edition of the issue report is available according to authority pre-granted to the account of each user terminal.

According to the exemplary embodiment of the present invention, it is possible to intuitively recognize an issue without actually visiting the site or convening an offline meeting for various construction and safety-related issues raised at the construction site, and particularly, it is possible to immediately deliver necessary information and have communication for resolving the issue, thereby achieving smooth work collaboration.

Further, according to the exemplary embodiment of the present invention, it is possible to rapidly and accurately deliver information about a specific issue of a construction site, and communication between multiple involved people may be efficiently performed.

### BRIEF DESCRIPTION OF THE DRAWINGS

FIG. 1 is a diagram illustrating a configuration of a three-dimensional space-based collaboration support system 100 using a building information model according to an exemplary embodiment of the present invention.

FIG. 2 is a conceptual diagram illustrating a collaboration support unit 130 that is connected to multiple user terminals to conduct video conferencing for an issue report.

FIG. 3 is a diagram illustrating a state in which three-dimensional location-based issue data is input through a user terminal.

FIG. 4 is a diagram illustrating a state in which a real-time chat based on BIM data between user terminals convened in a meeting is conducted regarding the created issue report.

FIG. 5 is a flowchart illustrating a sequence of examples of utilization of the three-dimensional space-based collaboration support system 100 using the building information model according to one exemplary embodiment of the present invention.

### DETAILED DESCRIPTION

An exemplary embodiment of the present invention provides a three-dimensional space-based collaboration support system using a building information model, the three-dimensional space-based collaboration support system including: a facility data storage unit 110 for storing facility data; a rendering unit 120 for rendering Building Information Model BIM data based on the facility data; and a collaboration support unit 130 for providing the BIM data to a plurality of user terminals, outputting the BIM data through each user terminal, creating an issue report based on three-dimensional location-based issue data for a facility inputted through a specific user terminal, and transmitting a meeting convening alarm to a user terminals corresponding to the issue report.

Hereinafter, an exemplary embodiment is presented for helping the understanding of the present invention. However, the following exemplary embodiment is merely provided for easier understanding of the present invention, and the contents of the present invention are not limited by the exemplary embodiment.

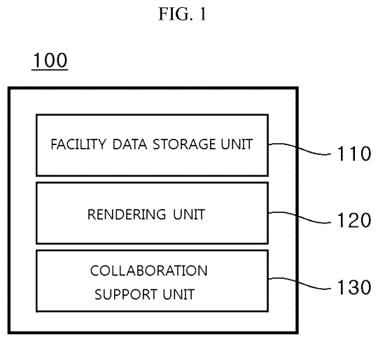

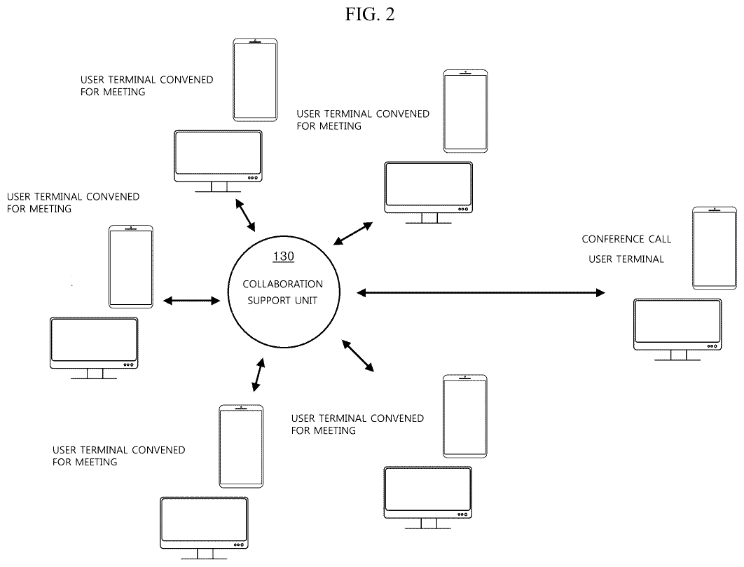

FIG. 1 is a diagram illustrating a configuration of a three-dimensional space-based collaboration support system 100 using a building information model according to an exemplary embodiment of the present invention, and FIG. 2 is a conceptual diagram illustrating a collaboration support unit 130 that is connected to multiple user terminals to conduct video conferencing for an issue report.

Referring to FIGS. 1 and 2, the three-dimensional space-based collaboration support system 100 using a building information model according to the exemplary embodiment of the present invention includes, in general, a facility data storage unit 110, a rendering unit 120, and a collaboration support unit 130. Here, the three-dimensional space-based collaboration support system 100 using the building information model according to the present invention is in the form of a server, which may be connected based on a wired or wireless network with each user terminal possessed by interested parties at a construction site, such as a plurality of workers, and managers.

First, the facility data storage unit 110 serves to store facility data required for the building and construction process. Here, facility data may be interpreted as a meaning including basic two-dimensional drawing data, terrain data, construction data, building data, and three-dimensional drawing data realized in a three-dimensional virtual space for a building or facility. In addition, facility data may be interpreted as a meaning including all documents and information required to build or construct a building or facility.

The rendering unit 120 serves to render Building Information Model (BIM) data based on the facility data stored in the facility data storage unit 110. More specifically, the rendering unit 120 implements a three-dimensional virtual space based on two-dimensional drawing data of the building or facility, and includes all information about all areas of the building or facility in the BIM data in the virtual space. The BIM data rendered through the rendering unit 120 may be provided and output to each user terminal through the collaboration support unit 130, and in this case, each user terminal may be a host terminal connected with the collaboration support unit 130. Thus, when an operation of each user terminal is performed, the rendering unit 120 renders BIM data in real time in response to the operation and provides the rendered BIM data to each user terminal, so that all user terminals participating in the meeting may share the same rendering screen.

BIM data may include three-dimensional images of buildings and facilities, information about the various members installed on site, and information about the users involved, such as workers and managers for each section and member of the building and facility. BIM data may also include specifications, materials, and brand information for each member.

Furthermore, when a screen operation is performed by a particular user terminal among the user terminals participating in a meeting, the rendering unit 120 provides the BIM data by reflecting the rendering result of the corresponding operation to the BIM data in real time to allow all users participating in the meeting to immediately share the screen.

The collaboration support unit 130 provides the BIM data rendered by the rendering unit 120 to all user terminals participating in the meeting (video conference, text meeting, etc.) to be output through the screen of each user terminal. In particular, the collaboration support unit 130 may serve to create an issue report based on three-dimensional location-based issue data of a facility inputted through a specific user terminal and transmit a meeting convening alarm to the user terminal corresponding to the issue report.

Here, the 3D location-based issue data for the facility inputted through the user terminal refers to data that a user located at the actual site creates for the 3D virtual space of a building or facility implemented and outputted on his/her user terminal to share and solve, with the people of the involved department, various problems and issues (for example, problems encountered during on-site inspection, defects in materials, quality, construction conditions, etc.) occurring in a specific location during the management and inspection of the site state. The three-dimensional location-based issue data may include location data on three-dimensional drawing data (three-dimensional virtual space) selected through the user terminal, photo data or video data taken through the user terminal. In addition to photo data or video data, the three-dimensional location-based issue data may also include textual data such as text, and may further refer to voice recording data that a user has recorded for the problem discovered while observing a specific location.

The three-dimensional location-based issue data basically includes location data through the user terminal generating the three-dimensional location-based issue data. Therefore, the rendering unit 120 may reflect the location data included in the three-dimensional location-based issue data in the previously rendered BIM data in real time, and the BIM data may be shared as the same screen to all user terminals involved.

When the three-dimensional location-based issue data is generated, the collaboration support unit 130 selects an account of a person in charge of the location data in the three-dimensional drawing data from among a number of registered accounts (users, workers, administrators, etc.), and transmits an issue report to the user terminal corresponding to the selected account.

More specifically, his/her work department is registered in each account during the registration process. Therefore, since the collaboration support unit 130 recognizes the work departments of all registered accounts in advance, when 3D location-based issue data is generated, the collaboration support unit 130 may automatically recognize the work department and the person in charge corresponding to the generated 3D location-based issue data. The collaboration support unit 130 automatically selects the account of the recognized person in charge and transmits an issue report to the user terminal corresponding to the account, to support the person in charge of the department to convene a meeting to resolve the issue at the location where the issue occurred.

In this case, the issue report may include all the information previously included in the three-dimensional location-based issue data, for example, location data of the location of the issue occurrence in the three-dimensional drawing data, and text data, photo data, video data, etc., of the issue content directly created through the user terminal, and the collaboration support unit 130 automatically creates the issue report in a format for a meeting convening request and transmits the issue report to the people in charge of the relevant department, thereby transmitting a meeting convening alarm to resolve the issue. In this case, all users attending the meeting may be already provided with BIM data reflecting the location of the issue occurrence in real time on their own user terminals, so that work efficiency may be maximized in that it is unnecessary to conduct separate work to recognize the location of the issue occurrence among multiple people in charge. In addition, all of the text-based chat windows may be provided for real-time communication between the respective user terminals during the meeting.

The collaboration support unit 130 may also support the selection of a person in charge directly through the user terminal that has input the three-dimensional location-based issue data (that is, the terminal of a person who has discovered an issue at the site and wishes to share the issue). More specifically, the collaboration support unit 130 may provide the user to directly select, from among a plurality of registered accounts, the department or account of the person in charge for resolving the issue or conducting a meeting related to the issue through the user terminal that has input the three-dimensional location-based issue data, and when the selection is completed, the collaboration support system 130 may transmit an issue report to the user terminal corresponding to the selected account of the person in charge, thereby enabling a meeting convening alarm to resolve the issue to be transmitted.

On the other hand, the collaboration support unit 130 may connect the user terminals that received the meeting convening alarm to each other on the same network to enable a videoconferencing processor to be executed, so that a video conference (which may be a text meeting) between the user terminals that received the meeting convening alarm is conducted. In this case, the user terminals participating in the video conference may be provided with BIM data reflecting the three-dimensional location-based issue data previously rendered in the rendering unit 120. Furthermore, by changing a host authority on a host user terminal hosting the meeting, not only the meeting organizer but also other users participating in the meeting may share various information, such as images, videos, and texts, required for the meeting.

Further, the collaboration support unit 130 may group the accounts into departments or people in charge based on the location data of each pre-registered account, and may transmit the meeting convening alarm to the user terminals of the grouped accounts so that the grouped accounts may participate in the video conference. As used herein, the grouped accounts may refer to building, architecture, or construction-related personnel associated with the location of issue occurrence. In addition, the collaboration support unit 130 may provide a function that allows users participating in the corresponding video conference to specify accounts that the user wants to join the video conference directly through their user terminals, so that the meeting convening alarm is transmitted directly to the user terminals of the specified accounts.

In addition, the collaboration support unit 130 may automatically convert voice output data generated during the course of the video conference into text data, and transmit and output the text data to user terminals corresponding to accounts previously grouped based on location data. Since the users of the accounts grouped based on the location data may be at the site or may be people who have difficulty in having the meeting through voice output or video output, the voice output data generated in the course of the video conference is automatically converted to text data and provided, so that users who cannot hear the sound or see the video may participate in the video conference smoothly.

Further, in the exemplary embodiment, the meeting content may all be stored in a separate database, and the meeting records stored in the corresponding database may be viewed via the user terminal while the meeting is in progress or even after the meeting has ended. This allows a user who joins a meeting later may quickly understand the progress and content of the meeting by viewing previous meeting records, thereby facilitating efficient meeting progress.

In addition, the collaboration support unit 130 may request the rendering unit 120 to display and output the location data corresponding to the three-dimensional location-based issue data as a specific symbol in the three-dimensional virtual space of the BIM data, and the rendering unit 120 may display the corresponding symbol in the virtual space of the BIM data output to each user terminal in response to the request. When any of the user terminals participating in the video conference selects the corresponding symbol, the collaboration support unit 130 may provide the issue report corresponding to the corresponding symbol so that viewing, modification, and edition of the issue report are available. Here, since the account on each user terminal may have different authority granted to each account upon initial registration, the collaboration support unit 130 may ensure that the process of modifying, editing, or adding comments proceeds differently depending on the authority granted to each account.

Further, in the exemplary embodiment, location information of meeting participants may be shared with respective user terminals in real time. In this regard, the location of each participant may be detected via GPS installed on the user terminal, and the corresponding location may be displayed on profiles of the meeting participants. Thus, when site inspections or actions are required in real-time during the meeting, the corresponding tasks may be assigned more efficiently based on the participant's location.

Next, a state in which three-dimensional location-based issue data is input through a user terminal and a state in which a real-time chat is conducted between user terminals regarding an issue report will be described.

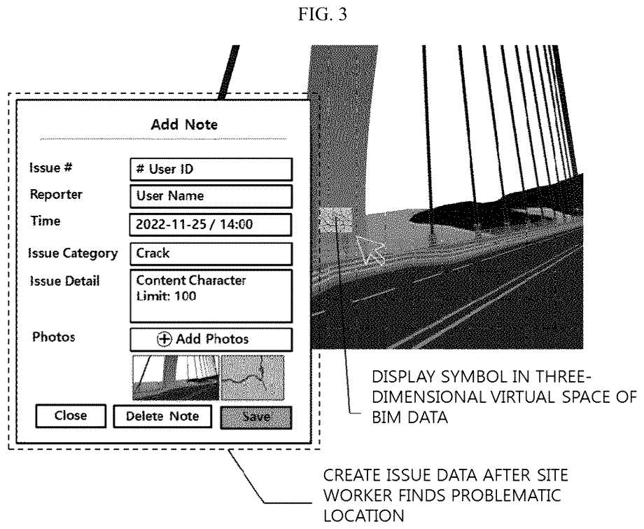

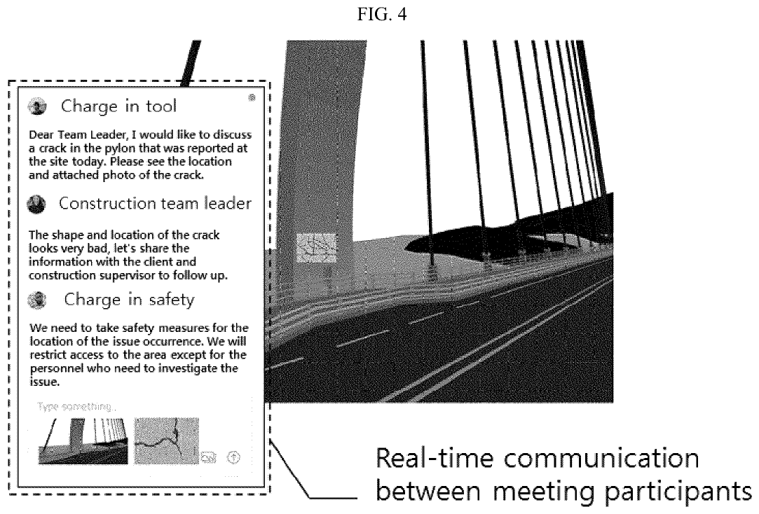

FIG. 3 is a diagram illustrating a state in which three-dimensional location-based issue data is input through a user terminal, and FIG. 4 is a diagram illustrating a state in which a real-time chat based on BIM data between user terminals convened in a meeting is conducted regarding the created issue report.

Referring now to FIG. 3, FIG. 3 is a diagram illustrating a screen of a user terminal for inputting three-dimensional location-based issue data. In this case, it may be seen that the BIM data rendered through the rendering unit 120 is implemented and output in a three-dimensional virtual space format on the screen of the user terminal. The user may input the three-dimensional location-based issue data by writing the contents of the site state, found problems, and issues through his/her user terminal.

In this case, the rendering unit 120 may reflect the three-dimensional location-based issue data to the BIM data based on the three-dimensional location information input through the user terminal. In addition, the three-dimensional location information written through the user terminal may be pointed in a symbol format. Further, in addition to text data, photo data or video data that is taken directly through the user terminal may also be attached in the process of writing the contents of the issue.

In addition, in the process of writing the three-dimensional location-based issue data of the corresponding location through the user terminal, the facility data storage unit 110 checks whether a previous record of the corresponding three-dimensional location information exists, and when the previous record exists, the three-dimensional location-based issue data may be written with a link for managing the history of the occurrence of the issue at the corresponding location. In addition, the user may set the location of interest, the member of interest, or the type of issue of interest through the user terminal to receive a meeting convening alarm for the department or management position to which the user belongs, and when an issue report related to the location of interest, the member of interest, or the type of issue of interest is created, the meeting convening alarm may be transmitted to the user terminal first.

Referring to FIG. 4, FIG. 4 is a screen showing the status of real-time communication via chat (text data) between user terminals participating in a video conference. In this case, the user terminal that has input the three-dimensional location-based issue data may invite a specific user terminal to convene a meeting, or the collaboration support unit 130 may transmit a meeting convening alarm to a user terminal corresponding to the issue report and invite the user to the conversation. In this case, not only text data-based communication is possible through the chat window, but also photo data, video data, and various materials for resolving the issue, and three-dimensional screen of the issue occurrence location to explain the status may be shared.

In other words, when a user terminal participating in the chat window performs an operation on the screen, the operation status is automatically transmitted to the rendering unit 120, and the rendering unit 120 reflects a result of the operation to the BIM data in real time as a rendering result in the BIM data and provides the BIM data, so that all participants may share a three-dimensional screen of the same BIM data.

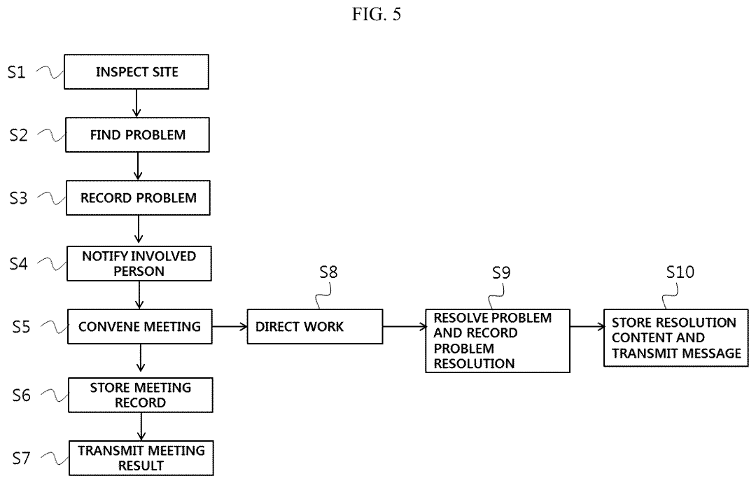

FIG. 5 is a flowchart illustrating a sequence of examples of utilization of the three-dimensional space-based collaboration support system 100 using the building information model according to one exemplary embodiment of the present invention.

Referring to FIG. 5, the three-dimensional space-based collaboration support system 100 using the building information model according to the exemplary embodiment of the present invention is used for efficient construction site monitoring by people involved in the construction site, such as multiple workers and managers.

First, a person located at a construction site conducts an inspection of a current status of the construction site, such as whether the construction site is being constructed according to design drawings and whether there are any abnormalities in installed members (S1). When problems are found during the site inspection (S2), the problems are recorded by selecting locations of the problems on a three-dimensional image (S3). The recorded content is stored as BIM data.

In this case, the site personnel may leave a textual record of the content of the problem and attach a photo or video of the problematic site. After the problem is recorded and stored, when a location of the problematic member is selected on the three-dimensional image, a corresponding history may be displayed in a separate pop-up window. The member that has a history of the problem is marked with a specific image or color on the three-dimensional image, and when the marked portion is selected, the history of the corresponding member may be displayed in a pop-up window.

When the content is recorded, the collaboration support unit 130 delivers a notification through a collaboration tool installed on the terminals of the people involved at the site (S4). The manager who receives the notification may convene a meeting regarding the corresponding issue as a host (S5). The meeting convening may induce the involved people for the location of the site or the involved people for the issue to attend the meeting by transmitting a meeting attendance notification to the involved people for the location of the site or the involved people for the issue or directly select the involved people for the site and invite the involved people directly to the meeting by the authority of a host.

The location information of the involved people for the corresponding site may be published to meeting participants. In this case, the involved people using the collaboration tool executed on each user terminal may select whether to disclose their locations in the collaboration tool settings. Therefore, only those who have agreed to disclose their location information may have their location information displayed in the collaboration tool.

This is so that a worker on a bridge or construction site that is several kilometers long or more may immediately expose his or her location after recognizing a location of a problematic member, so that other workers who are not on site may immediately recognize the location of the problematic member based on the location information of the corresponding worker.

When immediate on-site check or action is required, work may be efficiently directed by using the location information (S8). After the on-site check or action is taken, a record of the resolution of the problem is made (S9). These records are also saved as a history record for the corresponding location, and a message or a notification is transmitted to the involved people on the corresponding site via a collaboration tool (S10).

All meeting content may be stored in a database (S6). The user may navigate to the space where the meeting content is stored and check the content via a hyperlink displayed on the meeting terminal. The hyperlink is merged with a three-dimensional image and displayed on the terminal. A summary and a conclusion of the meeting content written by at least one of the meeting participants may also be stored as a history of the site along with the meeting content.

When the meeting record is stored, the collaboration support unit 130 transmits a result of the meeting record to the meeting participants and involved people. Involved people who were unable to attend the meeting may also receive the notification, and view the meeting by selecting a hyperlink to the corresponding location on the three-dimensional image even after the meeting has ended.

In the forgoing, the present invention has been described with reference to the exemplary embodiment of the present invention, but those skilled in the art may appreciate that the present invention may be variously corrected and changed within the range without departing from the spirit and the area of the present invention described in the appending claims.

1. A three-dimensional space-based collaboration support system comprising:
a facility data storage unit configured for storing facility data;
a rendering unit configured for rendering Building Information Model (BIM) data based on the facility data; and
a collaboration support unit configured for providing and sharing the BIM data to a plurality of user terminals, outputting the BIM data through each user terminal, creating an issue report based on three-dimensional location-based issue data for a facility inputted through a specific user terminal, and transmitting a meeting convening alarm to a user terminals corresponding to the issue report, and supporting a meeting to be held between the user terminals receiving the meeting convening alarm,
wherein, when a screen operation is performed by a specific user terminal among the user terminals participating in the meeting, the rendering unit is configured to reflect a result of the rendering corresponding to the operation in real time to the BIM data and cause the BIM data to be shared immediately through screens of all the user terminals participating in the meeting,
the collaboration support unit configured to:
connect user terminals that have received the meeting convening alarm to each other via a network to execute a video conference processor, so that a video conference is conducted between the user terminals; and
cause the BIM data corresponding to the issue report to be output on the user terminal participating in the video conference, transmits the meeting convening alarm to user terminals corresponding to accounts grouped based on the location data so that the accounts grouped based on the location data are capable of participating the video conference, and automatically converts voice output data generated in a course of the video conference into text data, and transmits and outputs the converted text data to the user terminals corresponding to the accounts grouped based on the location data,
when, authority of a host is changed on a host user terminal hosting the video conference, the collaboration support unit is configured to cause images, videos, and text required for the video conference to be shared through other user terminals participating in the video conference, and
the collaboration support unit is configured to:
after receiving feedback from each user terminal on whether to disclose a location, cause location data corresponding to the three-dimensional location-based issue data to be displayed and output as a specific symbol in the three-dimensional virtual space of the BIM data for the user terminal that transmits feedback agreeing to disclose the location; and
provide the issue report corresponding to the symbol so that viewing, modification, and edition of the issue report is available according to authority pre-granted to the account of each user terminal,
the three-dimensional location-based issue data inputted via the user terminal is location data on the three-dimensional drawing data selected via the user terminal, photo data or video data taken via the user terminal,
the facility data storage unit is configured to check whether a previous record exists for the three-dimensional location information in the process of writing the three-dimensional location-based issue data, and when the previous record exists, the three-dimensional location-based issue data includes a link for managing a history of issue occurrence at the location, and
a user sets a location of interest, a member of interest, or a type of issue of interest through each user terminal, and when three-dimensional location-based issue data related to the location of interest, member of interest, or issue of interest is generated, a meeting convening alarm is transmitted to each user terminal by the collaboration support unit.

2. The three-dimensional space-based collaboration support system of claim 1, wherein the facility data includes at least one of two-dimensional drawing data, three-dimensional drawing data, terrain data, construction data, and building data for the facility.

3. The three-dimensional space-based collaboration support system of claim 1, wherein the collaboration support unit is configured to select an account of a person in charge corresponding to location data in the three-dimensional drawing data selected via the user terminal from among a plurality of pre-registered accounts, and transmit the issue report to a user terminal corresponding to the selected account.

4. The three-dimensional space-based collaboration support system of claim 1, wherein the collaboration support unit is configured to transmit the issue report to a user terminal corresponding to an account of a person in charge, which is selected directly through the user terminal that has inputted the three-dimensional location-based issue data from among the plurality of pre-registered accounts.
